(19) United States
(12) Patent Application Publication
(10) Pub. No.: US 2011/0170024 A1
(43) Pub. Date: Jul. 14, 2011

(54) MONITOR

(75) Inventors: Hai-Qing Zhou, Shenzhen City (CN); Song-Lin Tong, Shenzhen City (CN)

(73) Assignees: HONG FU JIN PRECISION INDUSTRY (ShenZhen) CO., LTD, Shenzhen City (CN); HON HAI PRECISION INDUSTRY CO., LTD., Tu-Cheng (TW)

(21) Appl. No.: 12/768,709

(22) Filed: Apr. 27, 2010

(30) Foreign Application Priority Data
Jan. 11, 2010 (CN) 201010300172.2

(51) Int. Cl. H04N 5/64

(52) U.S. Cl. 348/843; 348/E05.128

(57) ABSTRACT

A monitor includes a main body and a control circuit. The main body includes a display and a shield. The control circuit drives a motor mounted to the main body. The control circuit detects a power status of the main body and controls the motor to rotate in response to the power status of the main body, so as to wrap the shield to uncover the display when the main body powers on, or to cover the display when the main body is idle or powers off.

### BACKGROUND

1. Technical Field

The present disclosure relates to monitors, and more particularly to a monitor which has a movable dust shield.

2. Description of Related Art

Commonly, monitors, such as liquid crystal displays, are often exposed to surrounding environments that have airborne dust particles and other contaminants in the air, the exposed displays can collect these dust particles and contaminants and become dusty, thus requiring frequent cleaning.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present embodiments. Moreover, in the drawings, like reference numerals designate corresponding parts throughout the several views.

FIG. 1 is an exploded, isometric view of an exemplary embodiment of a monitor.

FIG. 2 is a block diagram of a control circuit of the monitor of FIG. 1, in accordance with an exemplary embodiment.

FIG. 3 is an assembled, isometric view of the monitor of FIG. 1 excluding a front cover.

FIG. 4 is an assembled, isometric view of the monitor of FIG. 1.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

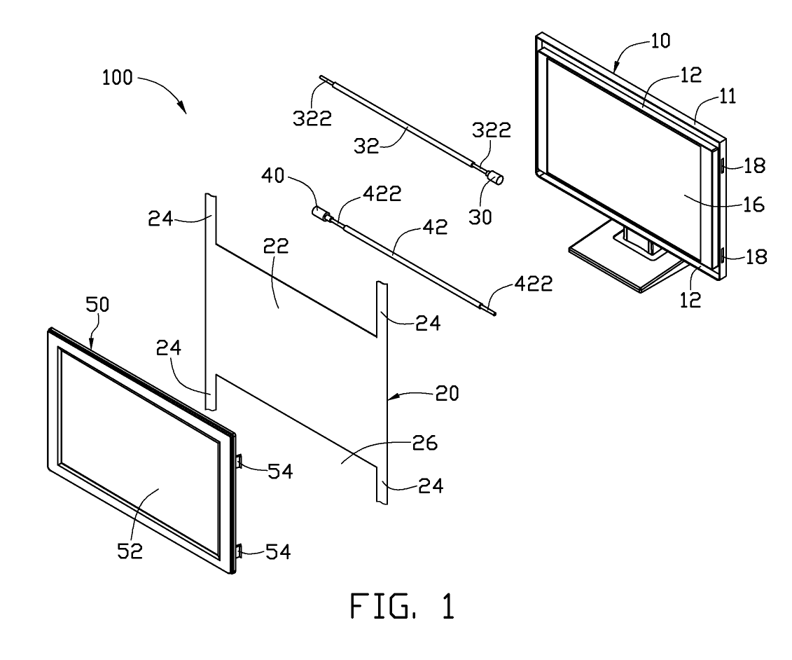

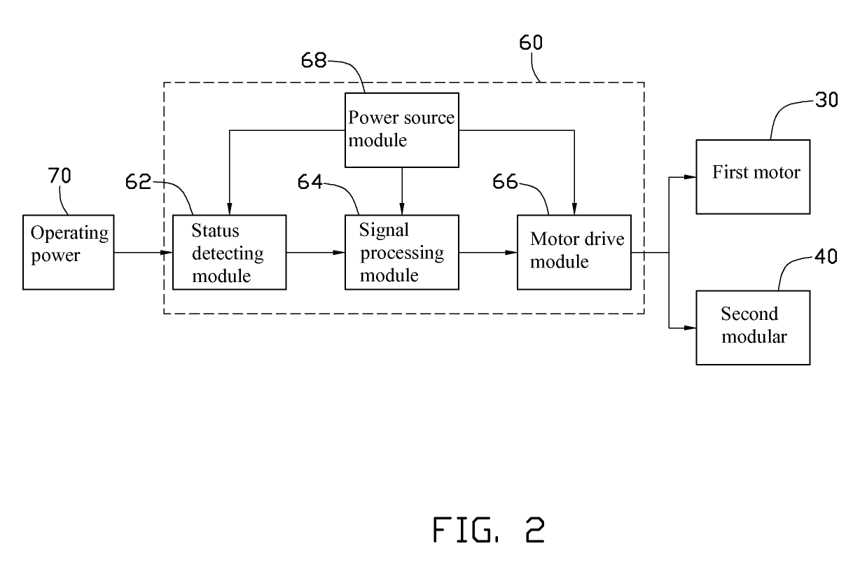

Referring to FIGS. 1 and 2, an exemplary embodiment of a monitor 100 includes a main body 10, a shield 20, a front cover 50, and a control circuit 60.

The main body 10 includes a rectangular back cover 11 and a rectangular display 16 contained in the back cover 11. A receiving groove 12 is formed between the display 16 and each side of the back cover 11. Two clip holes 18 are defined in each of two opposite sides of the back cover 11. The main body 10 also includes a circuit board (not shown) for controlling the display 16.

The shield 20 is substantially H-shaped, and includes a rectangular shielding portion 22 and four transporting belts 24 extending from the four corners of the shielding portion 22.

The front cover 50 is substantially rectangular. An opening 52 is defined in the front cover 50. Two clips 54 extend from each of two opposite sides of the front cover 50, corresponding to the clip holes 18 of the back cover 11.

The control circuit 60, which is integrated in the circuit board of the main body 10, drives a first motor 30 and a second motor 40. The control circuit 60 includes a status detecting module 62, a signal processing module 64, a motor drive module 66, and a power source module 68. In other embodiments, the control circuit 60 may be integrated in a single circuit board. The first motor 30 includes an axle 32 extending from the first motor 30. Two annular grooves 322 are respectively defined in two opposite ends of the axle 32. The second motor 40 includes an axle 42 extending from the second motor 40. Two annular grooves 422 are respectively defined in two opposite ends of the axle 42. Each of the grooves 322 and 422 is wider than a width of the corresponding transporting belt 24. Both of the first and second motors 30 and 40 include fixing portions (not shown), such as grooves or screw holes which allow mounting ability to the main body 10.

The status detecting module 62 is connected to the signal processing module 64. The signal processing module 64 is connected to the motor drive module 66. The motor drive module 66 is connected to the first and second motors 30 and 40. The power source module 68 is connected to the status detecting module 62, the signal processing module 64, and the motor drive module 66. The status detecting module 62 detects a power signal which indicates a status of the main body 10 from an operating power 70 of the main body 10. The power source module 68 may include batteries, to supply power to the status detecting module 62, the signal processing module 64, and the motor drive module 66.

In one embodiment, the signal processing module 64 may be a micro control unit. The motor drive module 66 may include a motor drive chip. The status detecting module 62, the signal processing module 64, the motor drive module 66, and the power source module 68 are implemented by known technology.

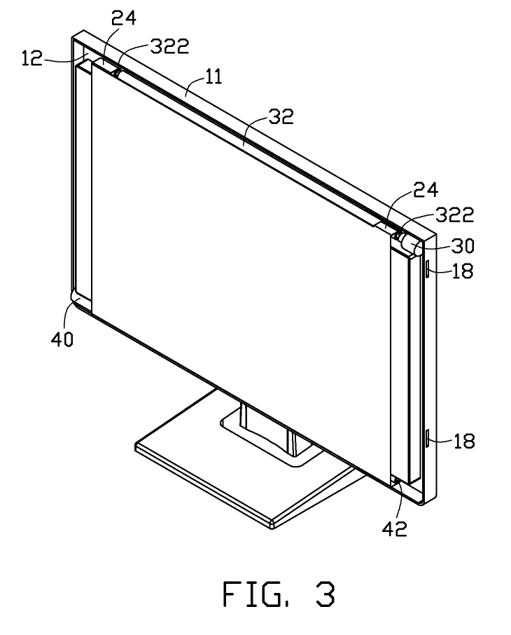

Referring to FIG. 3, in assembling of the first and second motors 30 and 40, the shield 20, and the main body 10. The first and second motors 30 and 40 are contained in the receiving grooves 12 of the main body 10 at the top and bottom of the display 16, and are fastened to the main body 10 by the fixing portions of the first and second motors 30 and 40. The transporting belts 24 of the shield 20 respectively wrap around the axles 32 and 42 in the grooves 322 and 422, with the shielding portion 22 covering the display 16 of the main body 10 completely.

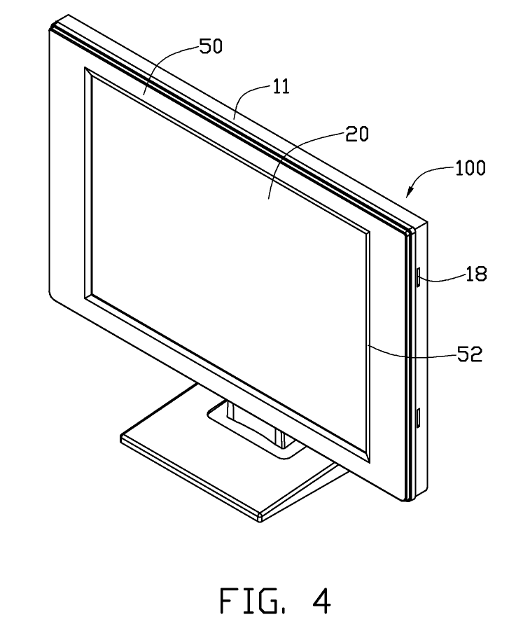

Referring to FIG. 4, the front cover 50 is attached to the main body 10, via engagement between the clips 54 of the front cover 50 and the clip holes 18 of the main body 10.

In use, before the main body 10 powers on, the shield 20 covers the display 16 completely. Once the main body 10 powers on, the power signal detected by the status detecting module 62 is at high voltage level, such as 12 volts. The status detecting module 62 outputs a detecting signal in response to the high voltage level of the power signal. The signal processing module 64 receives the detecting signal and performs status analysis of the main body 10 based on the detecting signal, and outputs first and second control signals corresponding to the status of the main body 10. The motor drive module 66 receives the first and second control signals. The motor drive module 66 sets parameters, such as rotating speeds, rotating laps, and rotating directions, in accordance with the first and second control signals. In addition, outputs a first and second driving signal respectively to the first and second motors 30 and 40, to control the first and second motors 30 and 40 to rotate in accordance with the parameters, respectively. The axle 32 further wraps the corresponding transporting belts 24, with lengths of the transporting belts 24 wrapped around the axle 32 increased. The lengths of the transporting belts 24 wrapped around the axle 42 are shortened, so the shielding portion 22 of the shield 20 is moved upwards until the shielding portion 22 is completely wrapped on the axle 32. Thus, the display 16 of the main body 10 is exposed through an opening 26 defined between the transporting belts 24 at a bottom of the shielding portion 22 adjacent to the second motor 40. The front cover 52 adjacent to the sides of the main body 10 covers parts of the transporting belts 24 unwrapped from the axle 42. In other embodiments, the shielding portion 22 may be wrapped by the axle 42 of the second motor 40 when the main body 10 powers on, or the second motor 40 may be omitted.

When the main body 10 is idle or powered off, the power signal detected by the status detecting module 62 is at low voltage level, such as 0 volts. The signal processing module 64 and the motor drive module 66 control the first and second motors 30 and 40 to rotate in a reverse direction relative to the direction mentioned above, until the shielding portion 22 of the shield 20 completely covers the display 16 to shield the display 16 from dust.

In other embodiments, the status detecting module 62 may include several sensors to detect a position of the shielding portion 22 of the shield 20 relative to the display 16 of the main body 10. Moreover, the signal processing module 64 and the motor drive module 66 correspondingly control the first and second motors 30 and 40 to wrap the shielding portion 22 to a predetermined position in real time. A number of the motors in other embodiments are determined according to needs. The first and second motors 30 and 40 may be mounted to the left and right sides of the main body 10 and the shielding portion 22 of the shield 20 may be moved from left to right or from right to left.

It is to be understood, however, that even though numerous characteristics and advantages of the present disclosure have been set forth in the foregoing description, together with details of the structure and function of the disclosure, the disclosure is illustrative only, and changes may be made in details, especially in matters of shape, size, and arrangement of parts within the principles of the disclosure to the full extent indicated by the broad general meaning of the terms in which the appended claims are expressed.

What is claimed is:

1. A monitor comprising:
a main body comprising a display and a shield;
at least one motor mounted to the main body; and
a control circuit to drive the at least one motor;
wherein the control circuit detects a power status of the main body to control the at least one motor to rotate in response to the power status of the main body being at high level, so as to wrap the shield to uncover the display, or to control the at least one motor to rotate in response to the power status of the main body being at low level, so as to spread the shield to cover the display.

2. The monitor of claim 1, wherein the main body comprises a back cover, wherein the display is contained in the back cover, a receiving groove is formed between the display and each of top and bottom of the back cover, the at least one motor comprises a first motor and a second motor respectively accommodated in the receiving grooves and each comprising an axle, a top and a bottom of the shield are respectively wrapped on the axles of the first and second motors.

3. The monitor of claim 2, wherein the shield comprises a rectangular shielding portion, at least one transporting belt extending from each of the top and bottom of the shielding portion, wherein when the shielding portion uncovers the display in response to the power status of the main body being at high level, the at least one transporting belt extending from the top of the shielding portion is wrapped on the axle of the first motor, the at least one transporting belt extending from the bottom of the shielding portion is wrapped on the axle of the second motor.

4. The monitor of claim 3, further comprising a front cover attached to the back cover, to sandwich the display between the front cover and the back cover, wherein the shield is placed between the front cover and the display, the front cover defines an opening to expose the display.

5. The monitor of claim 4, wherein two clip holes are defined in each of two opposite sides of the back cover, two clips extend from each of two opposite sides of the front cover to engage in the corresponding clip holes of the back cover.

6. The monitor of claim 3, wherein the at least one transporting belt of each of the top and bottom of the shielding portion comprises two transporting belts at opposite ends of the shielding portion, two annular grooves are respectively defined in two opposite ends of each of the axles of the first and second motors, to wrap the two transporting belts, each of the groove is longer than a width of a corresponding transporting belt.

7. The monitor of claim 3, wherein the control circuit comprising:
a status detecting module to detect a power signal from an operating power of the main body which indicates the power status of the main body, and to output a detecting signal in response to the voltage level of the power signal;
a signal processing module to receive the detecting signal and perform status analysis of the main body, and to output first and second control signals corresponding to the status of the main body; and
a motor drive module to receive the first and second control signals, and correspondingly output first and second drive signals respectively to the first and second motors to control the first and second motors to rotate to make the shielding portion uncover the display when the main body powers up or to make the shielding portion cover the display when the main body is idle or powered off.

8. The monitor of claim 1, wherein the main body comprises a back cover, wherein the display is contained in the back cover, a receiving groove is formed between the display and a top of the back cover, the at least one motor comprises a motor accommodated in the receiving groove and comprising an axle, a top of the shield is wrapped on the axle of the motor.

9. The monitor of claim 8, wherein the shield comprises a rectangular shielding portion, a transporting belt extending from the top of the shielding portion, wherein the shielding portion covers the display in response to the power status of the main body being at high level, the transporting belt is wrapped on the axle of the motor.
